(19) United States
(12) Patent Application Publication
(10) Pub. No.: US 2025/0176465 A1
(43) Pub. Date: Jun. 5, 2025

(54) ADJUSTABLE HARVESTER SYSTEMS AND METHODS FOR USE IN LIQUID ENVIRONMENTS

(71) Applicant: Eddy Pump Corporation, El Cajon, CA (US)

(72) Inventor: Daniel WAHLGREN, Escondido, CA (US)

(21) Appl. No.: 18/959,990

(22) Filed: Nov. 26, 2024

Related U.S. Application Data
(60) Provisional application No. 63/605,361, filed on Dec. 1, 2023.

(51) Int. Cl. A01D 44/00; E02B 15/10

(52) U.S. Cl. CPC A01D 44/00; E02B 15/102; E02B 15/108

(57) ABSTRACT

Harvester systems and methods for use in liquid environments are disclosed herein. In an embodiment, a harvester includes a cutter assembly and a frame. The cutter assembly is configured to remove solid material from a liquid environment and includes a cutter housing, one or more cutting blades for cutting the solid material, and a hose connector configured for connection to a hose for pumping the solid material out of the cutter housing. The frame is configured to attach the cutter assembly to a plurality of different vehicles configured to operate in the liquid environment and includes a first adjustment assembly adjustable for removable attachment to the plurality of different vehicles and a second adjustment assembly adjustable to raise the cutter assembly above a surface of the liquid environment and to lower the cutter assembly at least partially into the liquid environment.

### PRIORITY

This application claims priority to U.S. Provisional Application No. 63/605,361, filed Dec. 1, 2023 and entitled “Harvester,” the entire contents of which is incorporated herein by reference.

### FIELD OF THE PRESENT DISCLOSURE

The present disclosure generally relates to harvester systems and methods for use in liquid environments. In particular, the present disclosure generally relates to an adjustable harvester that can be used with various floating, submersible or semi-submersible vehicles to remove solid material such as seaweed from liquid environments.

### BACKGROUND

In recent years, excessive growth of sargassum has become a problem in certain warmer regions such as the Caribbean. Sargassum is a form of brown macroalgae (seaweed) that grows in shallow regions of temperate and tropical oceans. In limited amounts, sargassum that has washed ashore is helpful for maintaining coastal ecosystems. For example, sargassum provides vital nutrients such as carbon, nitrogen, and phosphorous. Sargassum can also be a food source. Since 2011, however, record amounts of sargassum have been burdening coastlines in eastern Florida, the Caribbean, and the Gulf of Mexico.

There are many problems associated with sargassum. Decomposition of large quantities of sargassum along coastlines consumes oxygen and can create oxygen-depleted zones that kill fish. Decaying sargassum also releases hydrogen sulfide gas, which can cause a range of health impacts on humans. Large amounts of floating sargassum also prevent corals and seagrasses from receiving sufficient light, clog marine propellers, and entangle turtles and other animals. Consequently, there is a need to remove sargassum from coastal areas to make the coastal areas more hospitable for both marine life and human activities.

Conventional seaweed removal equipment has been operated from the shore to collect seaweed from beaches. For example, handheld and large rakes pulled by a truck or a tractor have been used to remove seaweed from the beach. But the use of these tools requires allowing the seaweed to collect on the beach before it can be removed. When seaweed is raked from the beach, the seaweed can also be bulky and covered with sand. Bulky seaweed can be difficult to carry away, and seaweed covered with sand can damage the equipment used to treat the seaweed after collection.

### SUMMARY

It has been determined that there is a need for new systems and methods for removing seaweed that is near the shoreline or located in other portions of seas and oceans, but which has not yet washed up onto the beach. The systems and methods disclosed herein remove the seaweed while it is still in the water, providing advantages such as preventing the seaweed from collecting in sand and keeping heavy machinery off the coastal land.

In view of the state of the known technology, a first aspect of the present disclosure is to provide a harvester for removing solid material from a liquid environment. The harvester includes a cutter assembly and a frame. The cutter assembly is configured to remove the solid material from the liquid environment and includes a cutter housing, one or more cutting blades for cutting the solid material, and a hose connector configured for connection to a hose for pumping the solid material out of the cutter housing after being cut by the plurality of blades. The frame is configured to attach the cutter assembly to a plurality of different vehicles configured to operate in the liquid environment and includes a first adjustment assembly adjustable for removable attachment to the plurality of different vehicles and a second adjustment assembly adjustable to raise the cutter assembly above the surface of the liquid environment and to lower the cutter assembly at least partially into the liquid environment.

In an embodiment, the first adjustment assembly includes a first support member configured to attach to respective first parts of the plurality of different vehicles, a second support member configured to attach to respective second parts of the of the plurality of different vehicles, and a transverse support member enabling the first support member to translate towards and away from the second support member.

In an embodiment, the first support member includes a first adjustable clamp configured to clamp the respective first parts and a second adjustable clamp configured to clamp the respective second parts.

In an embodiment, the second adjustment assembly includes at least one vertical support member attached to the cutter assembly and configured to raise the cutter assembly above the surface of the liquid environment and to lower the cutter assembly at least partially into the liquid environment.

In an embodiment, the cutter assembly includes a housing for the one or more cutting blades which includes a front opening to receive the solid material for the one or more cutting blades to cut.

In an embodiment, the cutter assembly includes a rotating shaft extending in a lateral direction within the housing, and the one or more blades rotate around the shaft to cut the seaweed.

In an embodiment, the cutter assembly includes a hose connector configured to attach to a hose, so that the solid material cut by the cutter assembly is pumped away from the cutter assembly through the hose.

A second aspect of the present disclosure is to provide a harvester system for removing solid material from a liquid environment. The harvester system includes a cutter assembly, a vehicle and a pump hose. The cutter assembly includes a housing and one or more blades within the housing. The housing includes a front opening configured to receive the solid material from the liquid environment into the housing to be cut by the one or more blades. The vehicle supports the cutter assembly in the liquid environment such that the cutter assembly moves between (i) a first configuration in which the cutter assembly is located at a first vertical position above the surface of the liquid environment, and (ii) a second configuration in which the cutter assembly is lowered to a second vertical position so that the front opening of the housing is at least partially submerged into the liquid environment. The pump hose operably connects the cutter assembly to the pump such that the pump causes the solid material cut by the one or more blades to be pumped out of the housing and away from the vehicle.

In an embodiment, the vehicle includes at least one of a boat, a submersible vehicle, a semi-submersible vehicle.

In an embodiment, the vehicle includes a non-floating vehicle or machine operated from land adjacent to the liquid environment.

In an embodiment, in the second vertical position, the front opening of the housing is partially submerged into the liquid environment so that solid material floating on the surface and solid material located below the surface flows into the opening to be cut by the one or more blades as the vehicle moves the cutter assembly through the liquid environment.

In an embodiment, the solid material includes seaweed.

In an embodiment, the cutter assembly is configured to float with at least a portion of the one or more blades disposed below the surface of the liquid environment.

In an embodiment, the harvester system includes a pump located remotely from the vehicle and operatively attached to the pump hose. The pump is configured to pull the solid material cut by the one or more blades through the pump hose and away from the vehicle.

A third aspect of the present disclosure is to provide a method of removing solid material from a liquid environment. The method includes submerging a cutter assembly including a housing and one or more blades at least partially into the liquid environment in an area of the liquid environment containing solid material, moving the cutter assembly through the liquid environment while operating the one or more blades so that the solid material flows into the housing and is cut by the one or more blades, and pumping the solid material cut by the cutter out of and away from the cutter assembly via a hose operatively attached to the housing.

In an embodiment, moving the cutter assembly through the liquid environment includes propelling the cutter assembly through the liquid environment using a vehicle attached to the cutter assembly.

In an embodiment, moving the cutter assembly through the liquid environment includes moving the cutter assembly through the liquid environment with a non-floating vehicle or machine operated from land adjacent to the liquid environment.

In an embodiment, moving the cutter assembly through the liquid environment includes moving the cutter assembly through the liquid environment at a speed synchronized with a cutting rate and a suction flow rate.

In an embodiment, operating the one or more blades includes rotating a plurality of blades around a shaft extending in a lateral direction within the housing.

In an embodiment, the method includes adjusting a width of a frame connected to a cutter assembly to fit the frame to a vehicle operable in the liquid environment, and submerging the cutter assembly at least partially into the liquid environment after the vehicle has transported the cutter assembly to the area of the liquid environment containing the solid material.

A fourth aspect of the present disclosure is to provide a harvester that includes a frame and a cutter assembly. The frame is configured to be attached to a front end of a vehicle or other movable system and the cutter assembly is attached to the frame.

In an embodiment, the frame is adjustable in a widthwise direction of the vehicle or other movable system to accommodate a width of the vehicle or other movable system.

In an embodiment, the frame is configured to support the cutter assembly such that a height of the cutter assembly is adjustable in a vertical direction.

In an embodiment, the frame includes a first support member, a second support member, a transverse support member, and a cutter support structure. The first support member has a front end and a rear end. The second support member has a front end and a rear end. The transverse support member spans between the front end of the first support member and the front end of the second support member. The cutter support structure supports the cutter assembly at a position forward of the front ends of the first support member and the second support member.

In an embodiment, the cutter support structure is configured to adjustably support the cutter assembly between a first vertical position and a second vertical position. The first vertical position is a position in which the cutter assembly is completely above a liquid surface when the vehicle or other movable system is floating on the liquid surface, and the second vertical position is a position in which the cutter assembly is at least partially submerged below the liquid surface.

In an embodiment, a first adjustable side clamp is provided on the first support member, and a second adjustable side clamp is provided on the second support member. Each of the first adjustable side clamp and the second adjustable side clamp is adjustable to accommodate a thickness of a side wall of the vehicle or other movable system.

In an embodiment, the harvester further includes a pump and a suction hose. The suction hose is connected to a hose connector of the cutter assembly.

In an embodiment, the pump is an eddy pump.

In an embodiment, the harvester includes at least one float attached to the suction hose between the pump and the cutter.

In an embodiment, the cutter assembly includes a first wall and a second wall. A front opening of the cutter assembly is disposed between the first wall and the second wall. The cutter assembly is provided with a rotating blade disposed between the first wall and the second wall.

In an embodiment, the rotating blade is driven by a hydraulic motor.

A fifth aspect of the present disclosure is to provide a seaweed removal method including the steps of moving a vehicle in a forward direction along a liquid surface in an area where seaweed exists, and operating a harvester mounted to the vehicle to cut and remove the seaweed.

In an embodiment, the harvester includes a frame configured to be attached to a front end of the vehicle, a cutter assembly attached to the frame, and a pump. Operating the harvester includes operating the cutter assembly to cut seaweed, and operating the pump remove the seaweed by suction.

In an embodiment, the method includes moving the vehicle along the liquid surface from a first area to the area where the seaweed exists with the cutter assembly raised above the liquid surface, and lowering the cutter assembly into the water upon reaching the area where the seaweed exists.

In an embodiment, moving the vehicle in the forward direction includes moving the floating apparatus at a speed synchronized with a cutting rate of the seaweed cutter and a suction flow rate of the pump.

In an embodiment, the frame includes a first support member, a second support member, a transverse support member, and a cutter support structure. The first support member has a front end and a rear end. The second support member has a front end and a rear end. The transverse support member spans between the front end of the first support member and the front end of the second support member. The cutter support structure supports the cutter assembly at a position forward of the front ends of the first support member and the second support member.

In an embodiment, the cutter support structure is configured to adjustably support the cutter assembly between a first vertical position and a second vertical position. The first vertical position is a position in which the cutter assembly is completely above a liquid surface when the vehicle is floating on the liquid surface. The second vertical position is a position in which the cutter assembly is at least partially submerged below the liquid surface when the vehicle is floating on the liquid surface.

In an embodiment, a first adjustable side clamp is provided on the first support member and a second adjustable side clamp is provided on the second support member. Each of the first adjustable side clamp and the second adjustable side clamp is adjustable to accommodate a thickness of a side wall of the vehicle.

In an embodiment, the harvester further includes a suction hose. The suction hose is connected between the pump and a hose connector of the cutter assembly.

Embodiments of the present disclosure are able to remove seaweed existing on or near the surface of a body of water. Accordingly, the embodiments of the present disclosure can remove seaweed near a coastline before the seaweed becomes washed up onto the beach. Moreover, embodiments of the present disclosure can pump the removed seaweed material to a remote location disposed away from the harvester. Consequently, a smaller sized vehicle can be used because it is not necessary for the vehicle to carry the seaweed material after the seaweed is cut by the cutter assembly.

Other objects, features, aspects and advantages of the systems and methods disclosed herein will become apparent to those skilled in the art from the following detailed description, which, taken in conjunction with the annexed drawings, discloses exemplary embodiments of the disclosed systems and methods.

### BRIEF DESCRIPTION OF THE DRAWINGS

Referring now to the attached drawings which form a part of this original disclosure:

FIG. 1 illustrates a top perspective view of an example embodiment of a harvester system for removing solid material from a liquid environment in accordance with the present disclosure;

FIG. 2 illustrates another top perspective view of the harvester system of FIG. 1;

FIG. 3 illustrates a top plan view of the harvester system of FIG. 1;

FIG. 4 illustrates a side elevational view of the harvester system of FIG. 1 with the cutter assembly in a raised configuration above the water, with the parts of the harvester system located below the surface of the water shown in broken lines;

FIG. 5 illustrates a side elevational view of the harvester system of FIG. 1 with the cutter assembly located in the water, with the parts of the harvester system located below the surface of the water shown in broken lines; and

FIG. 6 illustrates a side elevational view of the harvester system of FIG. 1 with the cutter assembly located in water with seaweed at the surface.

### DETAILED DESCRIPTION

Selected embodiments will now be explained with reference to the drawings. It will be apparent to those skilled in the art from this disclosure that the following descriptions of the embodiments are provided for illustration only and not for the purpose of limiting the invention as defined by the appended claims and their equivalents.

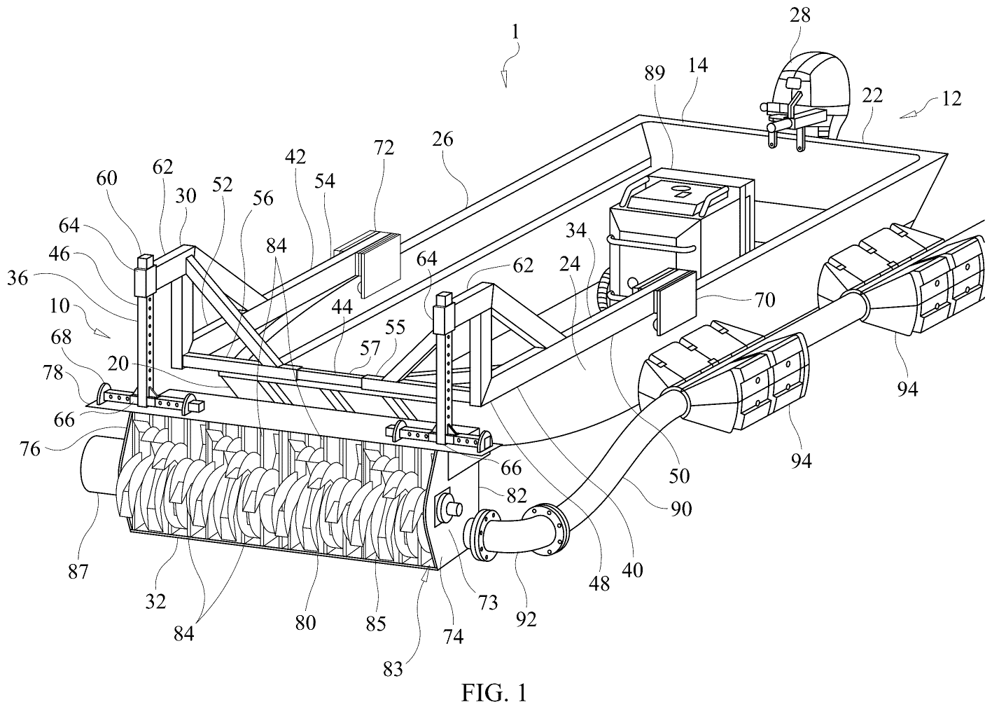

FIGS. 1 to 6 illustrate an example embodiment of a harvester system 1 for removing solid material (e.g., seaweed) from a liquid environment (e.g., ocean water). The harvester system 1 generally includes a harvester 10 attached to a vehicle 12. In use, the vehicle 12 propels the harvester 10 through the liquid environment while supporting the harvester 10 at or below the surface of the liquid environment such that certain parts of the harvester 10 can be raised above and lowered into the liquid environment to cut solid material accumulating at or below the surface. The liquid environment is generally water or a water/seaweed combination, but those of ordinary skill in the art will recognize from this disclosure that the devices and principles discussed herein may also be applicable to other liquids or liquid/solid combinations.

In the illustrated embodiment, the vehicle 12 is a boat including a hull 14 having a front side 20, a rear side 22, a first lateral side 24, a second lateral side 26, and a motor 28. The motor 28 is configured to propel the vehicle 12 through the liquid environment with the harvester 10 attached at the front side 20 of the vehicle 12. Although one type of boat is shown, the vehicle 12 can be other types of vehicles 12 configured to propel and/or support the harvester 10 at or below the surface of the liquid environment. For example, the vehicle 12 can be another type of floating apparatus operable in a liquid environment. The vehicle 12 can also be a submersible or semi-submersible vehicle configured to travel on the ground (e.g., ocean floor) beneath the liquid environment while supporting the harvester 10 as it removes solid material. Such a submersible or semi-submersible vehicle can be advantageous for shallow water or in areas where the water flow (e.g., wave action) makes operation of a boat difficult. As discussed in more detail below, the illustrated harvester 10 has a removably attachable and adjustable frame 30 which can be quickly and easily detached from one vehicle 12 and attached to another vehicle 12, for example, to operate in landscapes that have some areas too shallow for a boat and other areas too deep for a submersible vehicle.

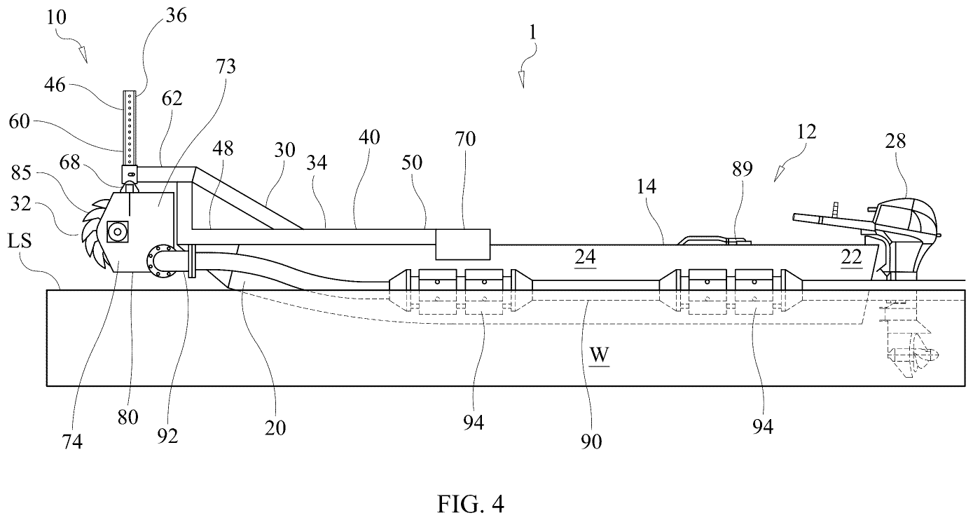

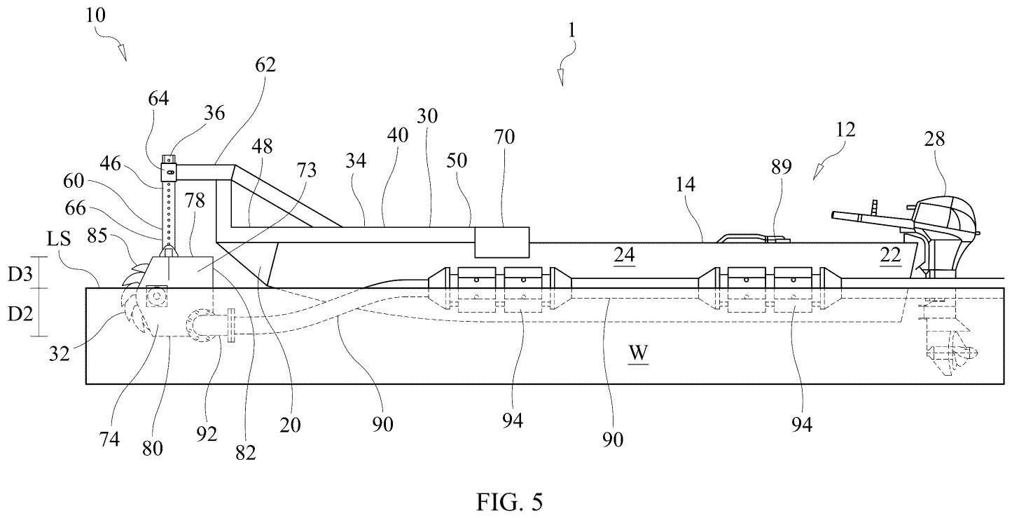

Referring first to FIGS. 1 to 3, the harvester 10 generally includes a frame 30 and a cutter assembly 32. The frame 30 is configured to support the cutter assembly 32 at the surface of the liquid environment such that a relative height of the cutter assembly 32 is adjustable in a vertical direction, for example, as shown in FIGS. 4 and 5. The frame 30 can be made of metal or another material of suitable strength and rigidity to support the cutter assembly 32. In the illustrated embodiment, the frame 30 is attached at the front side 20 of the vehicle 12, and the cutter assembly 32 is attached to the frame 30 so as to be positioned in front of the vehicle 12. This arrangement allows the vehicle 12 to propel the cutter assembly 32 into solid material (e.g., seaweed) at or below the surface of the liquid environment, so that the cutter assembly 32 receives and cuts the solid material before it interferes with other parts of the vehicle 12. For example, the cutter assembly 32 being positioned in front of the vehicle 12 as shown allows the cutter assembly 32 to cut seaweed and clear the path of the vehicle 12 so that the seaweed does not get caught in the motor 28 during use of the harvester system 1.

The frame 30 is adjustable in a widthwise direction of the vehicle 12 so that it can be attached to a plurality of different vehicles 12 of different sizes that are each configured to operate in the liquid environment. More specifically, the frame 30 includes a first adjustment assembly 34 configured to adjust in width for attachment to different types of vehicles 12, and a second adjustment assembly 36 configured to raise the cutter assembly 32 above the surface of the liquid environment and to lower the cutter assembly 32 at least partially into the liquid environment once the first adjustment assembly 34 has operatively attached the cutter assembly 32 to the desired vehicle 12.

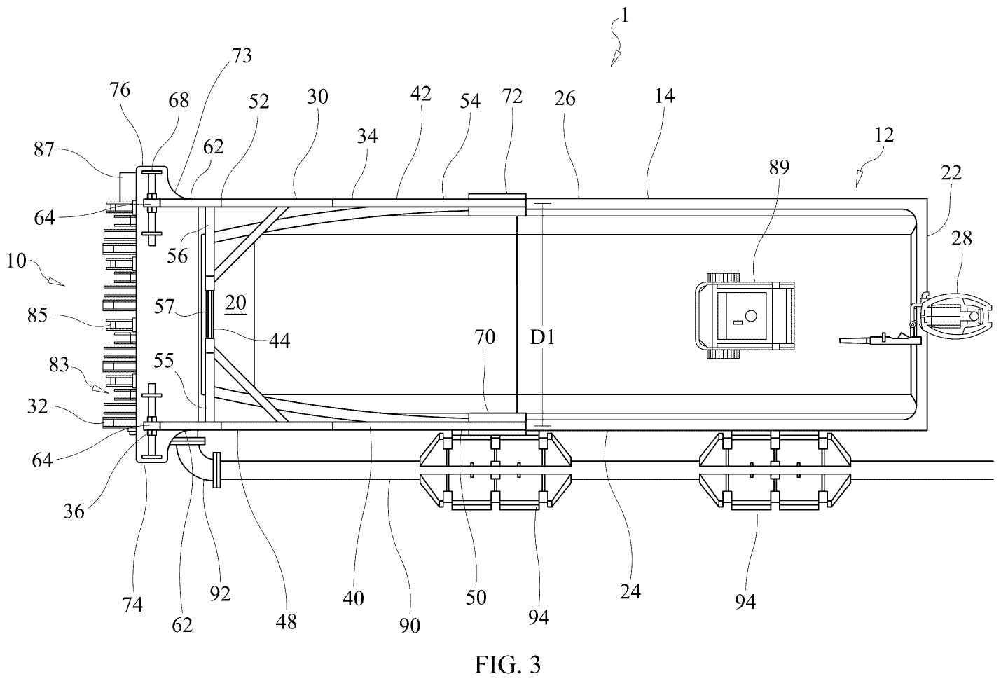

In the illustrated embodiment, the first adjustment assembly 34 of the frame 30 includes a first support member 40, a second support member 42, and a transverse support member 44, while the second adjustment assembly 36 includes a cutter support structure 46. The transverse support member 44 movably connects the first support member 40 to the second support member 42 such that the distance D1 (FIG. 3) between the first support member 40 and the second support member 42 can be adjusted to fit a corresponding width of the vehicle 12 to which the frame 30 is attached. The cutter support structure 46 is operatively connected to one or more of the first support member 40, the second support member 42, the transverse support member 44, or another extension of the first adjustment assembly 34. The cutter support structure 46 enables the cutter assembly 32 to be raised and lowered with respect to the first adjustment assembly 34.

In the illustrated embodiment, the first support member 40 is a longitudinally extending beam with a front end 48 and a rear end 50, and the second support member 42 is a longitudinally extending beam with a front end 52 and a rear end 54. Here, the transverse support member 44 spans the distance (e.g., the distance D1 in FIG. 3) between the front end 48 of the first support member 40 and the front end 52 of the second support member 42.

In the illustrated embodiment, the transverse support member 44 includes a first side support 55, a second side support 56 and connecting part 57. The connecting part 57 translates with respect to each of the first side support 55 and the second side support 56 to adjust the width of the frame 30 (e.g., the distance D1 in FIG. 3). In the illustrated embodiment, the first side support 55 and the second side support 56 include hollow outer beams and the connecting part 57 includes an inner beam extending partially within the hollow outer beams. The inner beam translates within each of the hollow outer beams to adjust the overall width between the first support member 40 and the second support member 42. In an embodiment, the inner beam includes a plurality of holes for inserting a pin, and the outer beams each include a pair of holes for inserting the pin into one or more holes of the inner beam so that the inner beam is prevented from moving further once the frame 30 is adjusted to the width of the vehicle 12. Alternatively, the connecting part 57 can include the hollow beam, and the first side support 55 and the second side support 56 can include inner beams extending partially into the outer beam. Those of ordinary skill in the art will recognize from this disclosure that other mechanisms can also be used to adjust the width of the frame 30 and/or moveably secure the first side 55, the second side 56 and the connecting part 57.

The cutter support structure 46 supports the cutter assembly 32 at a position forward of the front ends 48, 52 of the first support member 40 and the second support member 42. In other words, the frame 30 is configured to be attached to the front side 20 of the vehicle 12 and support the cutter assembly 32 in a position forward of the front side 20. As discussed above, this configuration allows the cutter assembly 32 to cut seaweed and clear the path of the vehicle 12 so that the seaweed does not get caught in the motor 28 or otherwise bog down the vehicle 12 during use of the harvester 10.

The cutter support structure 46 is configured to adjustably support the cutter assembly 32 between a first vertical position and a second vertical position. The first vertical position is located above the second vertical position when the harvester 10 is attached to the vehicle 12. In the illustrated embodiment, the cutter assembly 32 moves straight vertically between the first vertical position and the second vertical position, but in other embodiments, the cutter assembly 32 can also include other motions, for example, translate diagonally or by a combination of horizontal and vertical movements to move from the first vertical position to the second vertical position, and back from the second vertical position to the first vertical position.

FIG. 4 illustrates an example embodiment of the cutter assembly 32 at the first vertical position. The first vertical position is a position in which the cutter assembly 32 is completely above a liquid surface LS, for example, when attached to a vehicle 12 (here, a boat) that is floating on water W. This vertical position facilitates moving the vehicle 12 when the cutter assembly 32 is not being operated. For example, the cutter assembly 32 can be raised to the first vertical position before moving the vehicle 12 from a dock toward an area where seaweed removal work will be performed, or when moving the vehicle 12 back to the dock after completing the seaweed removal work.

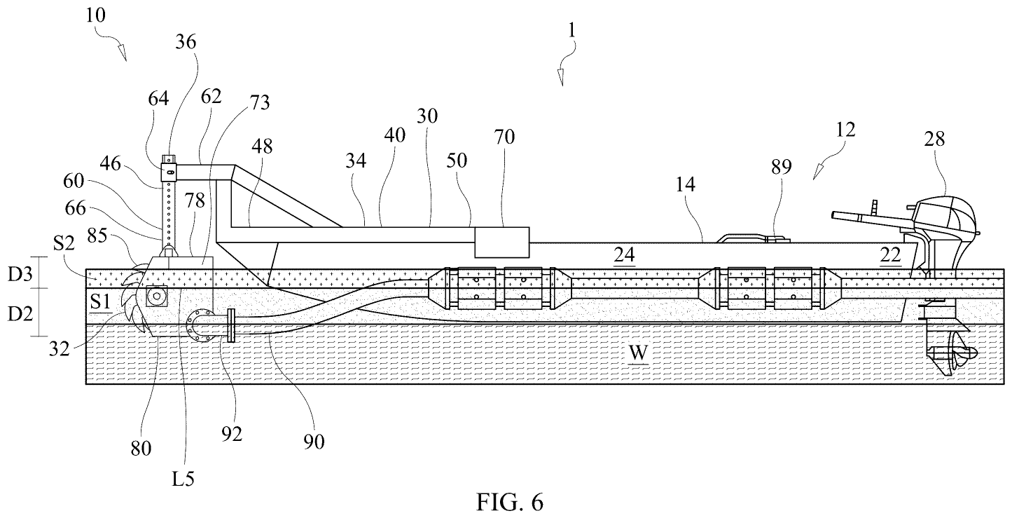

FIGS. 5 and 6 illustrate an example embodiment of the cutter assembly 32 at the second vertical position. The second vertical position is a position in which the cutter assembly 32 is at least partially submerged below the liquid surface LS. The second vertical position is preferably a position at which the cutter assembly 32 is almost completely submerged below the liquid surface LS. FIG. 5 shows the cutter assembly 32 at the second vertical position while in water W but before reaching any seaweed, while FIG. 6 shows the cutter assembly 32 at the second vertical position while in water W having seaweed S1, S2 at the surface both above and below the surface line LS. In FIG. 5, the cutter assembly 32 is a distance D2 below the surface of the water W and a distance D3 above the surface of the water, with the distance D2 larger than the distance D3. In FIG. 6, the cutter assembly 32 remains at the second vertical distance as the vehicle has entered an area of the water W including seaweed S1, S2, the water W and the seaweed S1, S2 represented by the shaded areas in FIG. 6. The seaweed S1, S2 includes seaweed S1 floating below the surface of the water W at a height slightly less than the distance D2, and includes seaweed S2 floating above the surface of the water W at a height slightly less than the distance D3. Thus, the second vertical position shown in FIG. 6 is optimal for this situation, but those of ordinary skill in the art will recognize from this disclosure that different relative positioning may be optimal for other situations with more seaweed above or below the surface of the water. In an embodiment, the cutter housing 73 and/or other parts of the cutter assembly 32 can be lowered completely below the surface of the liquid environment to remove seaweed or other material accumulating in lower depths.

Preferably, the cutter support structure 46 is configured such that the cutter assembly 32 is supported at a plurality of different positions between the first vertical position and the second vertical position. Depending on size and weight, for example, one vehicle 12 may sit lower in the water than another vehicle 12 or otherwise support the cutter support structure 46 at a different initial height. Other factors such as the type of seaweed being cut, the amount of seaweed in the area being worked, and the height of the seaweed above or below the liquid surface LS can require adjustment to the height of the cutter assembly 32. The cutting support structure 46 therefore should support the cutter assembly 32 at many different heights, such that each of the first vertical position and the second vertical position can be optimally established for different vehicles 12 and/or bodies of water. Thus, as used herein, the first vertical height is located vertically above the second vertical height, but the locations of the first vertical height and the second vertical height are established by the cutting support structure 46 and can change based on circumstances. In an embodiment, the second vertical position is the lowest vertical position which the seaweed cutter assembly 32 can be used effectively.

In some embodiments, the cutter support structure 46 is provided with a motorized mechanism for raising and lowering the cutter assembly 32 between the first vertical position and the second vertical position. Alternatively, the cutter support structure 46 can be configured to allow a user to raise and lower the seaweed cutter assembly 32 by hand or by using a hand-operated crank mechanism. The cutter support structure 46 is configured to support the cutter assembly 32 rigidly, particularly when the cutter assembly 32 is lowered to the second vertical position or another intermediate position suitable for performing seaweed removal work. In other words, the cutter support structure 46 supports seaweed cutter assembly 32 such that the seaweed cutter assembly 32 remains fixed and stable relative to the floating apparatus 12 during the seaweed removal work.

In the illustrated embodiment, the cutter support structure 46 includes a pair of vertical members 60 extending vertically from a pair of upper support members 62. The upper support members 62 extend forward from each of the first side support 55 and the second side support 56 and/or from each of the first support member 40 and the second support member 42. Here, the vertical members 60 are straight vertical and the upper support members 62 are straight horizontal, but the vertical members 60 and the upper support members 62 can also be diagonally vertical and/or horizontal and/or some other combination.

In the illustrated embodiment, the vertical members 60 are hollow beams with a plurality of holes for inserting a pin. Each of the upper support members 62 includes a hollow receiving portion 64 configured to receive one of the vertical members 60, with the receiving portion 64 including one or more holes for inserting the pin. The height position of the cutter assembly 32 can be adjusted by sliding the vertical members 60 up and down within the receiving portions 64, aligning one of the holes in each of the vertical members 60 with the holes in the receiving portions 64, and inserting the pins through the holes to secure the cutter assembly 32 at the selected height position.

While a mechanical moving structure is illustrated, other embodiments can include electrical motors that move the cutter assembly 32 up and down (or in any direction) and/or an automated system that adjusts the cutter assembly 32 to the optimal level for harvesting the solid material in the liquid environment. Such an automatic system can use sensors or cameras along with a processor to sense and determine the optimal level for the cutter based on the liquid surface level, the amount of seaweed or other solid material, or otherwise. Such information can be relayed to motors to adjust the cutter assembly 32 and/or to a display unit to enable an operator to adjust and/or view the cutter assembly 32 position. In an embodiment, the operator is capable of using the motors (or motor) to adjust the cutter assembly 32 and/or to position the cutter assembly 32 in the optimal position. Such adjustment can be performed via a display to by visually observing the cutter assembly 32.

In the illustrated embodiment, the cutter support structure 46 is further configured to accommodate different sizes and configurations of cutter assemblies 32. In the illustrated embodiment, the bottom ends 66 of the vertical members 60 and an upper portion or side portions of the cutter assembly 32 are provided with connecting parts 68 that enable the vertical members 60 and the cutter assembly 32 to be coupled together securely and rigidly. Here, the connecting parts 68 enable the cutter assembly 32 to be connected to the frame 30 when the first side support 55 and the second side support 56 and/or the first support member 40 and the second support member 42 are located at different distances with respect to each other to accommodate the width of the vehicle 12.

As discussed above, the frame 30 is configured to be attached to the front side 20 of the vehicle 12. The transverse support member 44 can be configured to extend and contract in a telescoping manner to adjust a distance between the first support member 40 and the second support member 42. Similarly, the first support member 40 and the second support member 42 can be configured to extend and contract to accommodate the shape of the vehicle 12. This way, the frame 30 can be adjusted to accommodate different vehicles 12 of different lengths, widths and shapes. In the illustrated embodiment, the frame 30 includes a first adjustable clamp 70 provided on the first support member 40 and a second adjustable clamp 72 provided on the second support member 42. Adjustable clamps can also be provided at other locations along the frame 30. Each of the first adjustable clamp 70 and the second adjustable clamp 72 is preferably adjustable to accommodate vehicles 12 having side walls of different thicknesses. Since the distance (e.g., distance D1 in FIG. 3) between the first adjustable clamp 70 and the second adjustable clamp 72 can be adjusted via the transverse support member 44, the first adjustable clamp 70 and the second adjustable clamp 72 can be adjusted to clamp onto the sides of the vehicle 12 or at another location of the vehicle 12 that is more suitable for secure attachment.

In the illustrated embodiment, the cutter assembly 32 includes a housing 73. Here, the housing 73 includes a first side wall 74 and a second side wall 76 joined by a top wall 78, a bottom wall 80 and/or a rear wall 82, giving the housing 73 a box-like shape with a front opening 83. Preferably, the top wall 78 and the bottom wall 80 are longer than the first side wall 74 and the second side wall 76 such that housing 73 has an elongated shape extending in the widthwise direction of the vehicle 12 as illustrated in FIGS. 1 to 3.

In the illustrated embodiment, the cutter assembly 32 includes one or more cutting blades 85 disposed within the housing 73. More specifically, the housing 73 includes a central shaft extending therein in the widthwise direction, and a plurality of blades 85 rotate around the shaft to cut seaweed or other solid debris that flows into the housing 73 through the front opening 83 as the cutter assembly 32 is propelled forward by the vehicle 12. Here, the rotating blades 80 are driven by a cutter motor 87 located adjacent the second side wall 76 of the housing 73. The cutter motor 87 can be any suitable motor known in the art that is capable of generating enough torque and speed to rotate the rotating blades 85 for cutting seaweed or other solid debris. Preferably the cutter motor 87 is adapted for marine use and can withstand being partially or completely submerged in seawater. In the illustrated embodiment, the harvesting system 1 also includes a portable power unit 89 for the cutter assembly 32. Here, the portable power unit 89 is a 25 HP hydraulic motor powered by a hydraulic power unit (HPU). The hydraulic power unit can be a portable HPU that can be easily loaded onto and unloaded from the floating apparatus 12 to power the cutter motor 87. The cutter assembly 32 can be powered in any suitable manner.

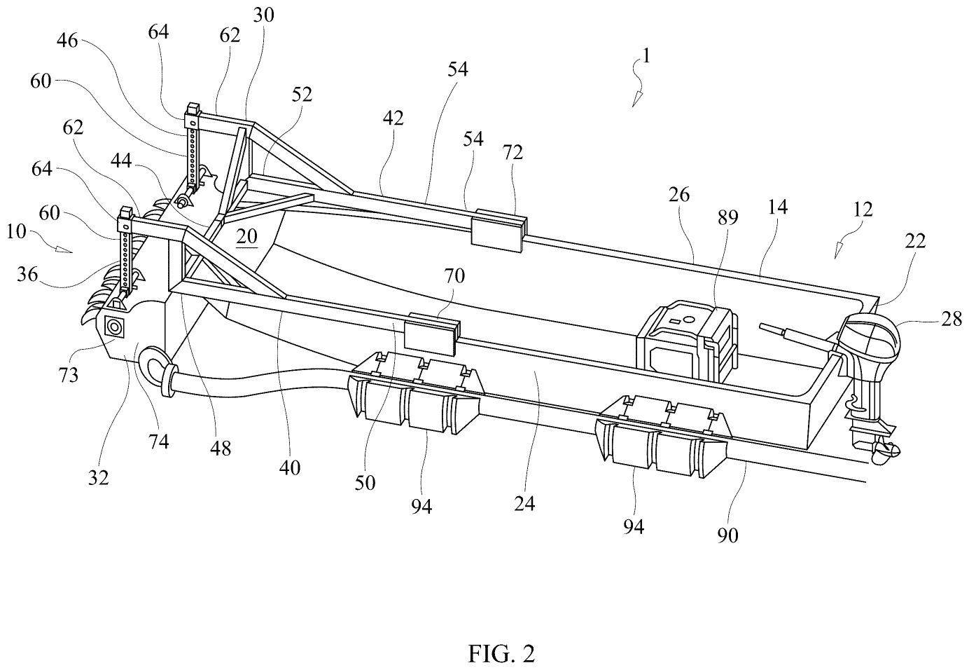

In an embodiment, the rotating cutting blade(s) 85 of the seaweed cutter assembly 32 can include a plurality of individual cutting blades 85 attached to a rotating shaft that is driven by the cutter motor 87. In the illustrated embodiment, each of the cutting blades 85 can have a generally circular disk-like shape with a portion cut away to form a protrusion or claw-like portion extending in a circumferential direction of the disk-like shape. Here, the blades 85 rotate on the shaft so as to move counterclockwise in FIGS. 2, 4, and 6. Partitioning walls 84 can also extend vertically from the bottom wall 80 to the top wall 78 of the housing 73 and be provided at positions between adjacent pairs of cutting blades 85. The partitioning walls 84 serve to secure the material of the seaweed while it is being cut by the cutting blades 85. Thus, once a portion of seaweed is caught by one of the cutting blades 85 and drawn in between the partitioning walls 84, the seaweed is held securely in place and reliably cut by the blade 85. Meanwhile, the front opening 83, one or more rear openings in the rear wall 82, and the spaces between the partitioning walls 84 allow water to flow through the cutter assembly 32 from front to rear during seaweed cutting work, thereby reducing the resistance to forward movement of the vehicle 12 and allowing cut seaweed material to flow rearward.

In an embodiment the cutter assembly 32 can float or have a float attached. In this embodiment, the cutter assembly 32 would float with at least a portion of the blades 85 disposed below the surface of the water. The cutter assembly 32 would be capable of free vertical movement so as to move with the surface of the liquid environment. In other words, when the surface of the water is not flat (i.e., has wave action), the cutter assembly 32 would be capable of maintaining the optimal vertical position to harvest the seaweed. In another embodiment, a computer control system is capable of monitoring and/or determining the optimal height of the cutter and continually adjusts the height of the cutter assembly 32.

In the illustrated embodiment, the harvester 12 also includes a pump and at least one suction hose 90. The cutter assembly 32 includes at least one hose connector 92 for connecting the suction hose 90. The suction hose 90 hose is connected between the pump and the hose connector 92 of the cutter assembly 32. At least one float 94 can be attached to the suction hose 90 to enable the suction hose 90 to float near the surface of the water even when the suction hose 90 is filled with cut seaweed material. Using floats 94 helps prevent the suction hose 90 from becoming entangled with obstacles under the water. This arrangement also helps ensure that the suction hose 90 remains relatively flat and parallel to the liquid surface, which facilitates efficient pumping of the cut seaweed material.

Various suction configurations can be utilized to suction the cut seaweed material from the seaweed cutter assembly 32. In the illustrated embodiment, the housing 73 of the cutter assembly 32 includes a hose connector 92 at one longitudinal end of the seaweed cutter assembly 32 (here, at the first side 74 of the housing 73). The hose connector 92 can be arranged at a rearward portion of one of the first side wall 74 or the second side wall 76 of the seaweed cutter assembly 32 such that suction is applied to an area rearward of the rotating blade(s) 80. In other embodiments, a second hose connector 92 can be provided on the other of the first side wall 74 and the second side wall 76 and a second suction hose 90 can be connected to the second hose connector 92 to provide suction from the opposite ends of the cutter assembly 32. The number of suction hoses 90 and suction hose connectors 92 is not limited to one or two and can be more as necessary. In another embodiment, a structure such as a pipe or passage provided with a plurality of suction ports can be arranged inside or behind the cutter assembly 32 and connected to the suction hose 90. The plurality of suction ports can distribute the suction more evenly along the lengthwise direction of the seaweed cutter assembly 32 (i.e., the widthwise direction of the floating apparatus).

The pump can be any type of pump suitable for suctioning seaweed material cut by the cutter assembly 32 and drawing the cut material through the suction hose 92. Preferably the pump is a self-priming pump. Typically, a self-priming pump includes an impeller and a volute casing. The impeller and volute casing can be surrounded by a tank so that it will always be immersed in a liquid sufficient to start the pump and provide the pump with lubrication and cooling. As can be understood, self-priming in this application means that the pump has the ability to use liquid stored in its housing to generate a vacuum on the suction line.

One example of a self-priming pump that can be used in accordance with the present application is an eddy pump. The eddy pump can be a pump as described in U.S. patent application Ser. No. 16/176,495, filed Oct. 31, 2018, and entitled Eddy Pump, the entire contents of which are herein incorporated by reference. Basically, an eddy pump includes a drive motor, a volute or housing, and a rotor. The rotor is disposed within the housing such that fluid, liquids, materials, and slurries can enter the housing and be pumped by the rotor. The rotor is connected to the drive motor that is configured to drive or rotate the rotor to pump fluid, liquids, materials, and slurries from the inlet to the discharge. The motor can be any suitable motor known in the art that would be capable of driving the rotor at suitable rotational velocities for suctioning the cut seaweed from the cutter assembly 32 through the suction hose 90.

Basic operation of the harvester 10 will now be explained. As discussed above, the harvester 10 is used by moving a vehicle 12 on which the harvester 10 is installed in a forward direction. The vehicle 12 propels the harvester 10 through a liquid environment where seaweed exists while the harvester 10 operates to cut and remove the seaweed in front of the vehicle 12. The cutter assembly 32 cuts the seaweed, while the suction hose 90 operates with a pump to remove the cut seaweed by suction. That is, while the seaweed cutter assembly 32 rotates the rotating blade 80 and cuts the seaweed, simultaneously the pump pulls the cut seaweed material through the suction pipe 90. The suction pipe 90 and the pump can be arranged to deposit the cut seaweed material in a suitable container or at some other discharge location so that the cut seaweed material can be stored or made ready for transport.

Before beginning cutting work, the vehicle 12 can be moved from a first area (e.g., a dock) to a liquid environment (e.g., a body of water) where the seaweed exists. During this movement, the cutter assembly 32 can be raised above the surface of the water to avoid unnecessary drag against the forward movement of the vehicle 12. After reaching the area where the seaweed will be cut, the cutter assembly 32 is lowered into the water at a height appropriate for the cutting work. During the cutting work, the vehicle 12 moves steadily forward at an appropriate speed. Preferably, the vehicle 12 moves at a speed synchronized with a cutting rate of the cutter assembly 32 and a suction flow rate of the pump. Advancing the vehicle 12 too quickly can cause the cutter assembly 32 to become clogged or result in poor cutting quality such that large amounts of the seaweed remain in place without being removed. Conversely, advancing the vehicle 12 more slowly than necessary can result in the cutting work proceeding slower than necessary without taking full advantage of the cutting capacity of the harvester 10.

A boat with a flat front end can be preferable for arranging the cutter assembly 32 in front of the vehicle 12. Although a metal jon boat is illustrated in the drawings, the present application is not limited to a jon boat. The first adjustable side clamp 70 and the second adjustable side clamp 72 can be adapted to fit a variety of sizes and configurations of jon boats or other vehicles 12. The frame 30 can also be adapted to be attached to a non-floating vehicle, such as an excavator, a telehandler, a remote-control autonomous vehicle, or another suitable type of work machine. In an embodiment, the harvester 10 is not limited to being operated from the water. The harvester 10 can be mounted to an excavator or other suitable machine that operates from the shore. The harvester 10 may also be mounted on a pole or other support structure that extends outward from the non-floating vehicle 12 so that the harvester 10 can be submersed in the water while the vehicle 12 moves on land along the shore or in shallow water near the shore.

In an embodiment, the vehicle 12 can be controlled without a human operator, for example, using GPS data. For example, in an embodiment, a GPS system can be used to locate remote areas of an ocean or other body of water containing excess amounts of seaweed, and a control system can control the vehicle 12 move the harvester 10 to the target area and then lower the cutter assembly 32 into the water upon reaching the target area. In an embodiment, GPS imaging or imaging or sensing performed on the vehicle 12 can be used to determine the thickness of the seaweed in the target area, and the vehicle 12 can automatically adjust its speed to synchronized with a cutting rate and/a suction flow rate. In an embodiment, a control system can use a lookup table to determine an appropriate cutting rate and/or suction flow rate based on a detected density or amount of seaweed. In another embodiment, the control system can speed up or slow down the vehicle 12 based on a detected resistance on the blades 85 of the cutter assembly 32.

The harvester 10 according to the present disclosure is also not limited to including a rotating blade 85 or other form of chopper that cuts up the material being collected. For example, the rotating blade 85 may be omitted and the harvester 10 may be used to collect material using suction alone. Moreover, the material collected is not limited to sargassum or other kinds of seaweed. It will be understood by those of ordinary skill in the art from this disclosure that the harvester 10 can be used to collect and remove any type of aquatic vegetation. Additionally, the harvester 10 may be used to collect trash, floating debris, or any other collectable material existing in the water.

The embodiments described herein provide mechanisms for removing seaweed, such as sargassum, from an area where the seaweed is disposed on, near and/or beneath the surface of a body of water. Also, the embodiments described herein enable the seaweed to be removed before the seaweed washes up on the beach. Moreover, a harvester 10 according to the present disclosure can be adapted to fit a variety of different vehicles 12. Thus, a user can use an existing vehicle 12 to perform the seaweed removal work without purchasing a dedicated vessel solely for the purpose of seaweed removal. Additionally, since the harvester 10 can be adapted to accommodate a relatively small vehicle 12, the harvester 10 can be used in shallow areas near a beach to prevent excess seaweed from washing onto the beach.

In understanding the scope of the present invention, the term “comprising” and its derivatives, as used herein, are intended to be open ended terms that specify the presence of the stated features, elements, components, groups, integers, and/or steps, but do not exclude the presence of other unstated features, elements, components, groups, integers and/or steps. The foregoing also applies to words having similar meanings such as the terms, “including”, “having” and their derivatives. Also, the terms “part,” “section,” “portion,” “member” or “element” when used in the singular can have the dual meaning of a single part or a plurality of parts. Also as used herein to describe the above embodiment(s), directional terms refer to those directions of a harvester configured to be mounted to a front end of a floating apparatus. Accordingly, these terms, as utilized to describe the present invention should be interpreted relative to the harvester.

The term “configured” as used herein to describe a component, section or part of a device or element includes hardware and/or software that is constructed and/or programmed to carry out the desired function.

The terms of degree such as “generally”, “substantially”, “about” and “approximately” as used herein mean a reasonable amount of deviation of the modified term such that the end result is not significantly changed.

While only selected embodiments have been chosen to illustrate the present invention, it will be apparent to those skilled in the art from this disclosure that various changes and modifications can be made herein without departing from the scope of the invention as defined in the appended claims. For example, the size, shape, location or orientation of the various components can be changed as needed and/or desired. Components that are shown directly connected or contacting each other can have intermediate structures disposed between them. The functions of one element can be performed by two, and vice versa. The structures and functions of one embodiment can be adopted in another embodiment. It is not necessary for all advantages to be present in a particular embodiment at the same time. Every feature which is unique from the prior art, alone or in combination with other features, also should be considered a separate description of further inventions by the applicant, including the structural and/or functional concepts embodied by such feature(s). Thus, the foregoing descriptions of the embodiments according to the present invention are provided for illustration only, and not for the purpose of limiting the invention as defined by the appended claims and their equivalents.

What is claimed is:

1. A harvester for removing solid material from a liquid environment, the harvester comprising:
a cutter assembly configured to remove the solid material from the liquid environment, the cutter assembly including a cutter housing, one or more cutting blades for cutting the solid material and a hose connector configured for connection to a hose for pumping the solid material out of the cutter housing after being cut by the plurality of blades; and
a frame configured to attach the cutter assembly to a plurality of different vehicles configured to operate in the liquid environment, the frame including a first adjustment assembly adjustable for removable attachment to the plurality of different vehicles and a second adjustment assembly adjustable to raise the cutter assembly above a surface of the liquid environment and to lower the cutter assembly at least partially into the liquid environment.

2. The harvester of claim 1, wherein
the first adjustment assembly includes a first support member configured to attach to respective first parts of the plurality of different vehicles, a second support member configured to attach to respective second parts of the of the plurality of different vehicles, and a transverse support member enabling the first support member to translate towards and away from the second support member.

3. The harvester of claim 2, wherein
the first support member includes a first adjustable clamp configured to clamp the respective first parts and a second adjustable clamp configured to clamp the respective second parts.

4. The harvester of claim 1, wherein
the second adjustment assembly includes at least one vertical support member attached to the cutter assembly and configured to raise the cutter assembly above the surface of the liquid environment and to lower the cutter assembly at least partially into the liquid environment.

5. The harvester of claim 1, wherein
the cutter assembly includes a housing for the one or more cutting blades, the housing including a front opening to receive the solid material for the one or more cutting blades to cut.

6. The harvester of claim 5, wherein
the cutter assembly includes a rotating shaft extending in a lateral direction within the housing, and the one or more blades rotate around the shaft to cut the solid material.

7. The harvester of claim 1, comprising
a hose connected at one end to the hose connector and at another end to a pump, the hose enabling the solid material cut by the cutter assembly to be pumped away from the cutter assembly by the pump.

8. A harvester system for removing solid material from a liquid environment, the harvester system comprising:
a cutter assembly including a housing and one or more blades within the housing, the housing including a front opening configured to receive the solid material from the liquid environment into the housing to be cut by the one or more blades;
a vehicle supporting the cutter assembly in the liquid environment such that the cutter assembly moves between (i) a first configuration in which the cutter assembly is located at a first vertical position above a surface of the liquid environment, and (ii) a second configuration in which the cutter assembly is lowered to a second vertical position so that the front opening of the housing is at least partially submerged into the liquid environment; and
a pump hose operably connecting the cutter assembly to a pump such that the pump causes the solid material cut by the one or more blades to be pumped out of the housing and away from the vehicle.

9. The harvester system of claim 8, wherein
the vehicle includes at least one of a boat, a submersible vehicle, a semi-submersible vehicle.

10. The harvester system of claim 8, wherein
the vehicle includes a non-floating vehicle or machine operated from land adjacent to the liquid environment.

11. The harvester system of claim 8, wherein
in the second vertical position, the front opening of the housing is partially submerged into the liquid environment so that solid material floating on the surface and solid material located below the surface flows into the opening to be cut by the one or more blades as the vehicle moves the cutter assembly through the liquid environment.

12. The harvester system of claim 8, wherein
the solid material includes seaweed.

13. The harvester system of claim 8, wherein
the cutter assembly is configured to float with at least a portion of the one or more blades disposed below the surface of the liquid environment.

14. The harvester system of claim 8, comprising
a pump located remotely from the vehicle and operatively attached to the pump hose, the pump configured to pull the solid material cut by the one or more blades through the pump hose and away from the vehicle

15. A method of removing solid material from a liquid environment, the method comprising:
submerging a cutter assembly including a housing and one or more blades at least partially into the liquid environment in an area of the liquid environment containing solid material;
moving the cutter assembly through the liquid environment while operating the one or more blades so that the solid material flows into the housing and is cut by the one or more blades; and
pumping the solid material cut by the cutter out of and away from the cutter assembly via a hose operatively attached to the housing.

16. The method of claim 15, wherein
moving the cutter assembly through the liquid environment includes propelling the cutter assembly through the liquid environment using a vehicle attached to the cutter assembly.

17. The method of claim 15, wherein
moving the cutter assembly through the liquid environment includes moving the cutter assembly through the liquid environment with a non-floating machine operated from land adjacent to the liquid environment.

18. The method of claim 15, comprising
moving the cutter assembly through the liquid environment includes moving the cutter assembly through the liquid environment at a speed synchronized with a cutting rate and a suction flow rate.

19. The method of claim 15, wherein
operating the one or more blades includes rotating a plurality of blades around a shaft extending in a lateral direction within the housing.

20. The method of claim 15, comprising
adjusting a width of a frame connected to a cutter assembly to fit the frame to a vehicle operable in the liquid environment, and
submerging the cutter assembly at least partially into the liquid environment after the vehicle has transported the cutter assembly to the area of the liquid environment containing the solid material floating.
